(19) United States
(12) Patent Application Publication
(10) Pub. No.: US 2025/0355732 A1
(43) Pub. Date: Nov. 20, 2025

(54) FLEXIBLE ANALYTICS ENGINE API USING NATURAL LANGUAGE

(71) Applicant: Microsoft Technology Licensing, LLC, Redmond, WA (US)

(72) Inventors: Jose Araujo BARRETO, Redmond, WA (US); Uday Kumar PASUMARTHY, Snohomish, WA (US); Kai Yiu LUK, Seattle, WA (US)

(73) Assignee: Microsoft Technology Licensing, LLC, Redmond, WA (US)

(21) Appl. No.: 18/665,751

(22) Filed: May 16, 2024

(51) Int. Cl. G06F 9/54; G06F 16/242

(52) U.S. Cl. CPC G06F 9/543; G06F 16/243

(57) ABSTRACT

A data processing system includes an Application Programming Interface (API) handler for an analytics engine. The API handler to perform functions of: receiving user input including a natural language description that defines data a user wants from the analytics engine; generating a submission for a generative artificial intelligence (GenAI) based on the user input, the submission including the natural language description, schema of datasets stored in a database of the analytics engine, and an instruction to produce a query for the database; submitting the generated submission to the GenAI and receiving a corresponding query from the GenAI; submitting the query from the GenAI to the database of the analytics engine to generate a result set specific to the natural language description of the user input; and outputting, via an API, the result set.

### BACKGROUND

An analytics engine is a sophisticated software system designed to sift through vast amounts of data, discern patterns, and extract actionable insights. In large cloud and other services, an analytics engine may be extremely helpful to administrators who need to understand what is happening in the system. Consequently, the output from an analytics engine enables data-driven decision-making processes within organizations. For example, a cloud service that provides sites to a large population of tenants will generate vast amounts of data about those sites, usage, user behavior, permissions to access or edit content, etc.

At its core, an analytics engine ingests data from relevant and sometimes diverse sources, for example, databases, cloud platforms, media feeds, etc. The engine then undergoes a series of preprocessing steps to clean, transform, and structure the data, making it amenable to analysis. Once the data is acquired and prepared, the analytics engine employs a range of statistical techniques, machine learning algorithms, and data mining approaches to uncover insights. These insights can then be visualized through charts, graphs, and dashboards, allowing users to explore and understand the data intuitively.

An analytics engine often interfaces with external systems and services via Application Programming Interfaces (APIs). APIs act as bridges, enabling seamless communication between the analytics engine and other software applications, data sources, or services. The analytics engine will also have its own API through which it can receive administrator queries and output reports or other data analysis.

One of the key strengths of an analytics engine lies in its ability to scale horizontally, leveraging distributed computing frameworks or cloud infrastructure to handle large volumes of data efficiently. Additionally, some analytics engines support real-time analytics, enabling organizations to derive insights from data streams as they arrive, rather than relying solely on historical data. However, given the volume of data handled, the number of ways that data might be analyzed and the variety of formats in which data or insights might be output, operating an analytics engine can become challenging. For example, an administrator will need to be well educated in the capabilities and output forms that an analytics engine provides and the commands or input needed to invoke a desired report or analysis from the engine. This presents a technical problem in that the interface for the analytics engine may become difficult to operate, particularly if an administrator is not familiar with the capabilities and output forms that the analytics engine provides.

### SUMMARY

In one general aspect, the instant disclosure presents a data processing system that includes an Application Programming Interface (API) handler for an analytics engine. The API handler to perform functions of: receiving user input including a natural language description that defines data a user wants from the analytics engine; generating a submission for a generative artificial intelligence (GenAI) based on the user input, the submission including the natural language description, schema of datasets stored in a database of the analytics engine, and an instruction to produce a query for the database; submitting the generated submission to the GenAI and receiving a corresponding query from the GenAI; submitting the query from the GenAI to the database of the analytics engine to generate a result set specific to the natural language description of the user input; and outputting, via an API, the result set.

In another general aspect, the instant disclosure presents a data processing system including an Application Programming Interface (API) to receive user input including a natural language description defining data a user wants from an analytics engine; a prompt generator and grounding database, the prompt generator to generate a submission comprising grounding data from the grounding database, the grounding data including schema of a database of the analytics engine, the submission further comprising the user input and a prompt to produce a query for the database of the analytics engine; and an Application Programming Interface (API) handler to input the generated submission to a Generative Artificial Intelligence (GenAI) and receive a corresponding query from the GenAI, the API handler further to submit the query to the database of the analytics engine and receive a result set specific to the user input, the API handler further to return the result set in an API response.

In yet another general aspect, the instant disclosure presented a method of operating an analytics engine to obtain a specific data output specified by user input, the method including: receiving the user input including a natural language description that defines data a user wants from the analytics engine; generating a submission for a generative artificial intelligence (GenAI) based on the user input, the submission including the natural language description, schema of datasets stored in a database of the analytics engine, and an instruction to produce a query for the database in a format compatible with the database of the analytics engine; submitting the generated submission to the GenAI and receiving a corresponding query from the GenAI; submitting the query from the GenAI to the database of the analytics engine to generate a result set specific to the natural language description of the user input; and outputting the result set via an Application Programming Interface (API) to a system from which the user input was received.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system for an analytics engine based on principles discussed herein.

FIG. 2 depicts another system illustrating technical problems to be solved by the principles discussed herein.

FIG. 3 depicts additional possible details for the system of FIG. 2

FIG. 4 depicts additional details in another example of the system of FIG. 1

FIG. 5 depicts a more specific example of a system such as that of FIG. 1

FIG. 6 is a flow chart illustrating a method of operating a system according to the principles described herein.

FIG. 7 is a block diagram illustrating an example software architecture, various portions of which may be used in conjunction with various hardware architectures herein described.

FIG. 8 is a block diagram illustrating components of an example machine configured to read instructions from a machine-readable medium and perform any of the features described herein.

### DETAILED DESCRIPTION

As noted above, given the volume of data handled, the number of ways that data might be analyzed and the variety of formats in which data or insights might be output, operating an analytics engine can become challenging. Frequently, a user may not have sufficient technical training to operate the analytics engine but may want to obtain information from the data store, for example, to use in marketing or business analysis. In such a case, that user may need assistance from an administrator or operator of the analytics engine to code a query to the analytics engine that will produce the information or insights the user wants to see. For example, the user may ask for a list of all tenants that have a specified amount of data stored in the service, or for a list of all permissions for specific sites belonging to a tenant.

If the user is making a similar query to one previously coded, the query statement used previously may be available to use with updated input parameters. Otherwise, a new query statement will have to be written by a knowledgeable database administrator or software developer to produce the desired information.

In these various scenarios, a database administrator or software developer will need to be well educated in the capabilities and output forms that an analytics engine provides and the commands or input needed to prepare a query that will invoke a desired report or analysis from the engine. This presents a technical problem in that the interface for the analytics engine may become difficult to operate, particularly if an administrator is not familiar with the capabilities and output forms that the analytics engine provides.

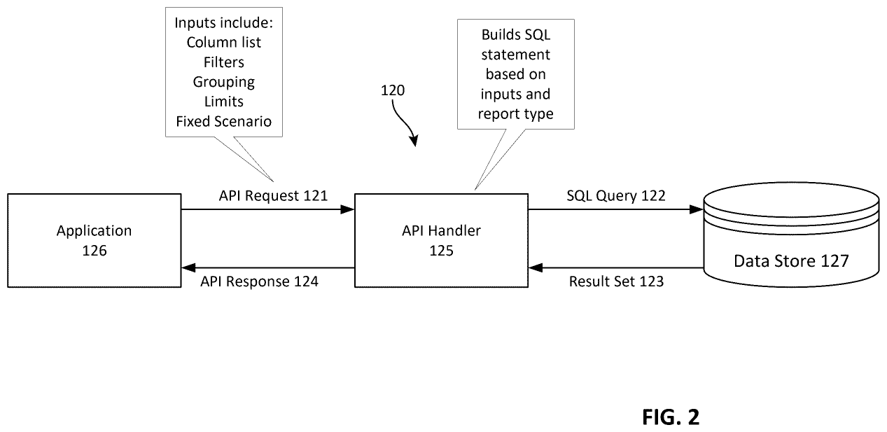

These technical issues are further discussed here with reference to FIG. 2. As shown in FIG. 2, an analytics engine may include a data store 127 and an API handler 125 to process requests for data in a particular format and/or with specific content from the data store 127. An application 126 is operated by a user to interact with the analytics engine to obtain desired information.

In this example, the queries to the data store 127 are prepared using Structured Query Language (SQL). SQL is a domain-specific language used in programming and designed for managing, retrieving, and manipulating data stored in relational database management systems (RDBMS). SQL allows users to perform various tasks such as querying databases to retrieve specific information, inserting new records, updating existing records, and deleting records. SQL is a standard language, but different database management systems may implement it slightly differently. This complicates the technical problems presented to a user needing to obtain information from the data store 127.

As shown in FIG. 2, the user operates the application 126. The application 126 communicates, via its own API, with the API handler 125. To obtain information from the data store 127, the user operates the application 126 to generate an API request 121 to the API handler 125. The API request 121 will identify specific parameters for the information that the user wants to see. For example, the input could include a column list, data filters, grouping instructions, limits, etc. These parameters apply to a fixed scenario around which an SQL query or statement has previously been prepared.

The API handler 125 then uses the specific input from the API request 121 to build an SQL query based on the fixed scenario the user is invoking. The specific parameters from the API request 121 are implemented in the SQL query 122. The query 122 is then submitted to the data store 127. The data store 127 processes the SQL query 122 and returns a result set 123 to the API handler 125. The API handler 125 then returns the data in an API response 124 to the application 126. At the application 126, the retrieved and organized information is provided or displayed to the requesting user.

This allows the client application to request data, for example, for a specific report. These client requests are essentially an API call, with a set of pre-defined input parameters that can include filtering, ordering or limiting the output. This contract may also include a specific output format, with a pre-defined set of columns. For instance, in the example of a cloud service supporting tenant sites, an oversharing report includes a list of sites with data such as site id, site name, site owner and the number of users with access to the site. There are options to exclude sites by type, sort by the number of users with access and to limit the output to a specific number of rows. The system 120 may offer a number of reports in different scenarios, including a list of permissions for a sites. Each of these requests have their own specific filtering, ordering, limiting and output columns. For that reason, each of these reports needs its own unique code used by the application 126 and the API handler 125.

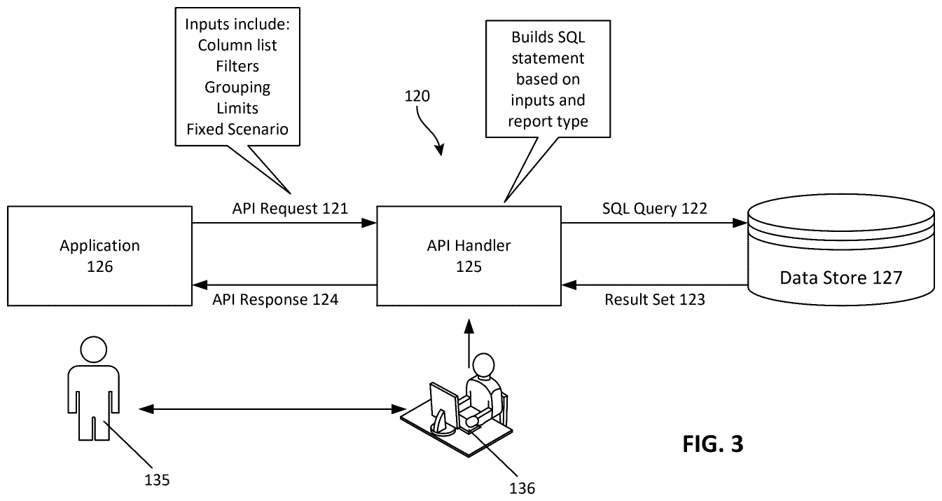

FIG. 3 illustrates a similar system, but illustrates the situation in which the user 135 wants to retrieve data or analysis from the data store 127 in a format or report that has not been done before or for which the API handler 125 does not already have an SQL statement template from which to build the SQL query 122. In this case, the user 135 may need to contact an administrator 136 for assistance.

Perhaps the user 135 wants to generate a new report with data organized in a specific manner, and no such report has been generated previously. In this case, the user 135 contacts the administrator 136 to describe the new report, for example, the content, format and any analysis needed to result in data as needed or desired by the user. The database administrator or software developer 136 then codes an SQL statement or statement template based on the specifications of the user 135. This work is then loaded into the API handler 125.

At this point, the system is ready to function as described in FIG. 2. Specifically, the user 135 can now submit an API request 121 with the input needed for a specific iteration of the newly-created form. The API handler 125 will now be able to build a corresponding SQL statement in the input of the API request 121. As before, the query 122 is submitted to the data store 127. The result set 123 is returned to the API handler 125 and, in turn, the API response 124 is returned to the application 126.

This approach is time-consuming for both the user 135 and the database administrator or software developer 136. Consequently, the following description provides a system that allows the user 135 to access data in different ways and formats, as desired, without having to rely on the administrator to write a new query structure each time the user wants to change what is being analyzed and reported by from the data store 127.

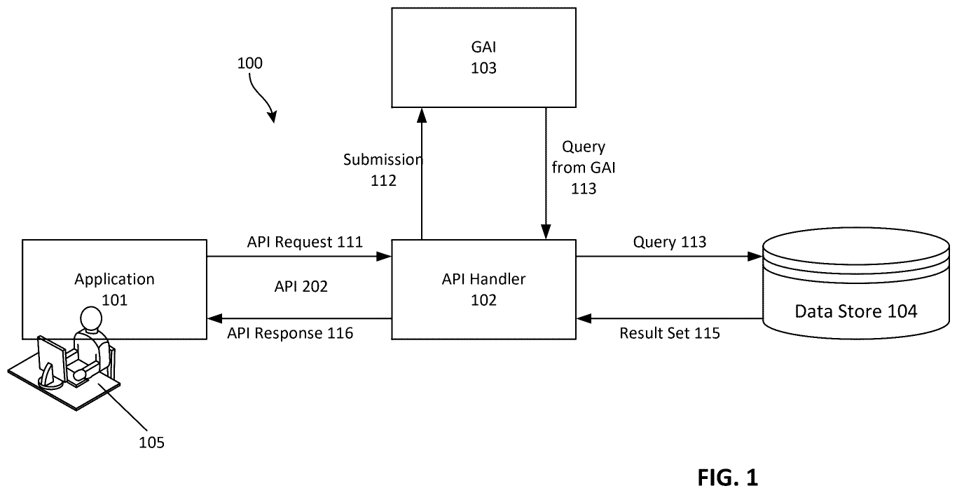

Referring now to FIG. 1, FIG. 1 depicts an example system for an analytics engine based on principles discussed herein. As shown in FIG. 1, the system includes a Generative Artificial Intelligence (GenAI) and related features to solve the technical problems described above. The GenAI can be, for example, a Large Language Model (LLM) such as a Generative Pre-Trained Transformer (GPT) or other LLM.

GenAI refers to artificial intelligence systems that can create new content or data that is similar to the data set on which the GenAI has been trained. This creation process involves generating original outputs, such as text, images, or even music, rather than simply recognizing or categorizing existing data. A Language Model (LM) is a type of generative AI that specializes in understanding and generating human or computer language. Within the realm of language models, some Large Language Models (LLMs) are particularly powerful due to their vast size and extensive training data. Specifically, a GPT is an LLM that has been trained on huge datasets comprising text from various sources, enabling a GPT to understand and generate human-like text across a wide range of topics and styles.

In the example system of FIG. 1, the GenAI will be used to generate a query, for example an SQL query, to be used in the analytics engine including the API handler 102 and data store 104. As shown in FIG. 1, a user 105 is operating a workstation that supports an application 101. This application could be, for example, the admin center page of a cloud service. With this application 101, the user 105 requests and receives data and analysis from the analytics engine. However, the user 105 need not be an administrator of the analytics engine and need not have any ability to code a query in the form or language required by the data store 104.

Rather, the user 105 can enter a natural language description of the data that the user wants to see. As used herein, “natural language” refers to a human language that would be written or spoken by a user and in which the user can describe what information is wanted. For example, assuming the data store 104 stores information for a service the supports sites for a wide variety of different tenants, the user 105 could enter a natural language request such as the following: Create a list of the sites that are not of web template id 21. The output must include a site id, site name, site URL, site owner name, site owner e-mail and the number of users with access. Sort the output by the number of users with access to the site. Limit the output to the top 1000 sites. In another example, the user 105 could enter a natural language request such as: Create a list of all permissions for the site with id 1234. The output should include the site id, site name, item type, item URL, Role definition, whether this is a link, type of shared with, name of shared with and e-mail of shared with.

The application 101 will include a user interface and controls, such as a text box or text editor or processor, with which the user can enter a natural language request to be completed by the analytics engine, including the data store 104. The interface of the application 101 will also include controls for the user, after drafting a natural language request, to submit a corresponding API request 111 that includes the natural language description of what the user wants.

An API handler 102 will use the natural language description to generate a submission 112 for a GenAI 103. The term “submission,” as used herein, refers to an input prepared for a GenAI to cause the GenAI to output a corresponding response based on its training. The generation of the submission 112 will be described in more detail below. In total, the submission 112 includes the details about the request from the user and corresponding grounding data with an instruction or “prompt” to implement the request the user is making. The grounding data describes for the GenAI the data structure and content of the analytics engine. For example, the grounding data could specify data types and relationships in the analytics engine. The grounding data is generally input to the GenAI when initiating a session and is then followed by a prompt. This will be described in further detail below. In some examples, the prompt includes which output columns to include along with filtering, and what ordering and limiting to apply.

The API handler 102 then submits the submission 112 to the GenAI 103. The submission 112 will instruct the GenAI 103 to return a query in the structure or language used by the data store 104, where the query implements the natural language request input by the user 105. The GenAI 103 will accordingly return a requested query 113 to the API handler 102. The API handler 102 will then submit the query 113 to the data store 104. The data store 104 will process the query 113 and output the desired information as a result set 115. The result set 115 is received by the API handler 102. The API handler 102 packages the result set as an API response 116 that is returned via API 202 to the application 101. The result set, which is the information the user requested, is then made available to the user 105 in the application 101.

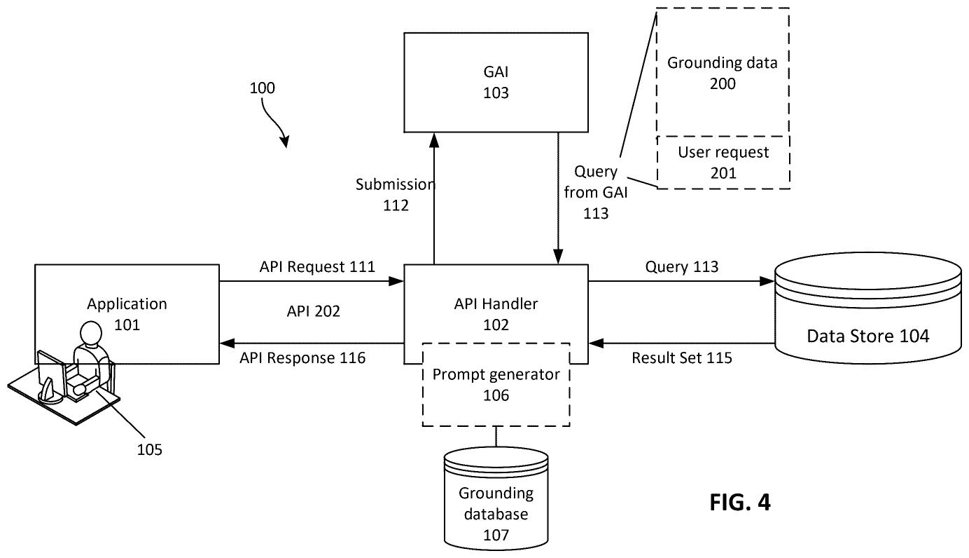

FIG. 4 depicts additional details in another example of the system of FIG. 1, including components used by the API handler 102 to generate the submission 112. As shown in FIG. 4, the API handler 102 includes a prompt generator 106. The prompt generator 106 has access to a grounding database 107. The grounding database 107 includes information specific to the analytics engine and data store 104. For example, the grounding database 107 stores the schemas and relationships for the datasets stored in the data store 104.

When the application 101 submits an API request 11 including the user's natural language request, the prompt generator 106 of the API handler 102 combines the user's natural language request 201 with grounding data 200 from the grounding database 107. This grounding data 200, being specific to the data store 104, will enable the GenAI 103 to produce a query 113 that is effective in the data store 104, i.e., is accepted by and compatible with the operation of the data store 104. In this way, the GenAI 103 can be a generally trained GenAI and need not be a GenAI that is specifically trained to produce queries for the data store 104. Specifically, the GenAI can be a generally trained LLM or GPT.

An example given above of a user natural language request was “Create a list of the sites that are not of web template id 21. The output must include a site id, site name, site URL, site owner name, site owner e-mail and the number of users with access. Sort the output by the number of users with access to the site. Limit the output to the top 1000 sites.” To generate a prompt for this request, the prompt generator 106 will combine the natural language request with grounding data from the grounding database 107. For example, the completed submission to the GenAI may include:
a. An indication of the query language to be used, e.g., SQL.
b. Schema or table definitions for the data in the data store 104, e.g., for sites, permissions and groups
c. Additional schema information, for example,
   i. Information Barriers Mode can be Open, Owner Moderated, Implicit, Explicit or Inferred.
   ii. ItemType can be Site, Folder or File.
   iii. Operation is the extraction mode of this row, which could be Full, Created, Updated or Deleted.
   iv. The SharedWith type can be a User or a Group.
   v. The Permissions has a SiteId foreign key for Sites
   vi. The Permissions has a SiteId and SharedWith_EmailAddress into Groups with SiteId and Member_Email, but only when the SharedWith_Type is Group.
      Taken together, a-c above is an example of grounding data for a submission to the GenAI. The submission then concludes with a prompt, i.e., an instruction to implement the natural language request from the user. In this example, such an instruction could read: “With that information, write a SQL query to do this: Create a list of the sites that are not of web template id 21. The output must include a site id, site name, site URL, site owner name, site owner e-mail and the number of users with access. Sort the output by the number of users with access to the site. Limit the output to the top 1000 sites.”

This completes the submission 112 produced by the prompt generator 106. As described above, the submission 112 is then submitted by the API handler 102 to the GenAI 103 to ultimately generate the result set 115 and API response 116 to the application 101 and the user 105.

The submission 112 described above could generate the following SQL query from the GenAI 103. This specific example was prepared using a GPT-4 GenAI which has good training for SQL.

```
SELECT TOP 1000
  s.Site_Id,
  s.RootWeb_Title AS Site_Name,
  s.Site_Url,
  s.Owner_Name AS Site_Owner_Name,
  s.Owner_Email AS Site_Owner_Email,
  COUNT(p.SharedWith_EmailAddress) AS NumberOfUsersWithAccess
FROM
  Site s
LEFT JOIN
  Permissions p ON s.Site_Id = p.SiteId
WHERE
  s.RootWeb_WebTemplateId < > 21
GROUP BY
  s.Site_Id, s.RootWeb_Title, s.Site_Url, s.Owner_Name, s.Owner_Email
ORDER BY
  NumberOfUsersWithAccess DESC;
```

This query selects the top 1000 sites where the RootWeb_WebTemplateId is not 21. It joins the site table with the permissions table to count the number of unique users with access to each site. The results are grouped by the site's details and ordered by the number of users with access in descending order.

The other natural language example noted above was “Create a list of all permissions for the site with id 1234. The output should include the site id, site name, item type, item URL, Role definition, whether this is a link, type of shared with, name of shared with and e-mail of shared with.” A submission 112 for this request could include the same grounding data described above with the instruction: “Write a SQL query to do this: Create a list of all permissions for the site with id 1234. The output should include the site id, site name, item type, item URL, Role definition, whether this is a link, type of shared with, name of shared with and e-mail of shared with.”

An illustrative SQL query produced by GenAI in response to this prompt is as follows:

```
SELECT
  s.Site_Id,
  s.RootWeb_Title AS Site_Name,
  p.ItemType,
  p.ItemURL,
  p.RoleDefinition,
  CASE
    WHEN p.LinkId IS NOT NULL THEN ‘Yes’
    ELSE ‘No’
  END AS Is_Link,
  p.SharedWith_Type,
  p.SharedWith_Name,
  p.SharedWith_EmailAddress
FROM
  Site s
JOIN
  Permissions p ON s.Site_Id = p.SiteId
WHERE
  s.Site_Id = ‘1234’;
```

This query joins the Site table with the Permissions table on the Site_Id field to retrieve all permissions related to the site with id 1234. It includes the site id, site name, item type, item URL, role definition, a check for whether the permission is linked, the type of entity the item is shared with, and the name and email of the shared entity. The CASE statement is used to determine if the permission is a link based on the presence of a LinkId.

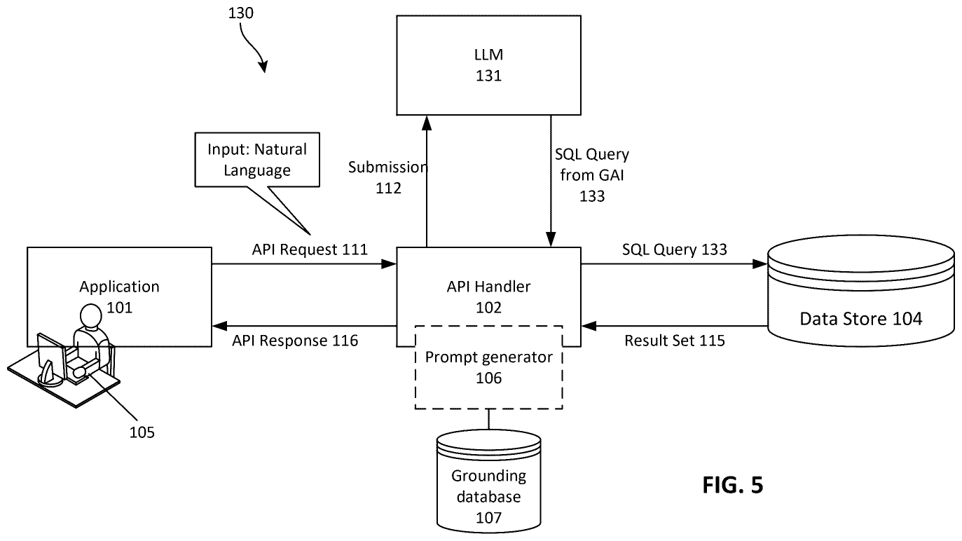

FIG. 5 depicts a more specific example of a system such as that of FIG. 1. In the example of FIG. 5, the GenAI is an LLM 131 and the data store 104 specifically operates using SQL. While SQL has been mentioned above, the previous data stores are not limited to SQL data stores and may operate using any alternative query structure. However, the example in FIG. 5 is specifically an SQL data store 104. Consequently, the submission 112 specifically includes an instruction to prepare a query using SQL, as in some examples above. The LLM 131 accordingly outputs an SQL query 133 which is then submitted by the API handler 102 to the data store 104.

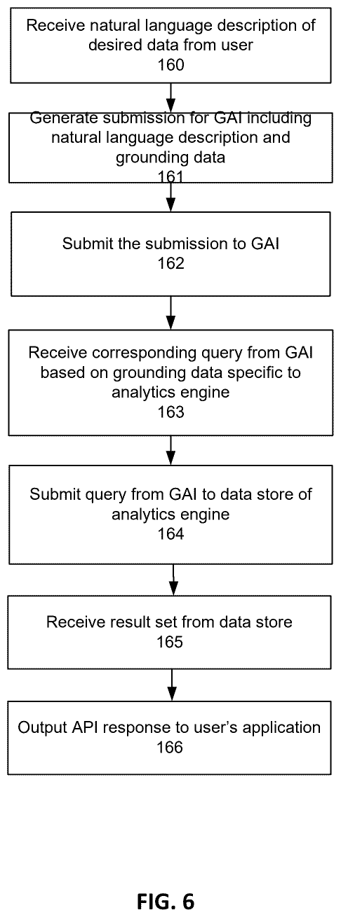

FIG. 6 is a flow chart illustrating a method of operating a system according to the principles described herein. The example method is from the perspective of the API handler described above. As shown in FIG. 6, the method begins with receiving 160 a description, in natural language, of data desired by the user from the analytics engine. Next, a prompt for a GenAI is generated 161. The prompt includes the natural language description from the user, perhaps with edits or revisions, and grounding data specific to the analytics engine and its data store.

The prompt is the submitted 162 to a GenAI. The GenAI then generates and returns a corresponding query based on the grounding data specific to the analytics engine. This corresponding query is received 163 and then submitted 164 to the data store of the analytics engine. A result set is then received 165 from the data store. This result set is formulated into an API response that is output 166 to the requesting application and user.

This approach provides the following advantages. It provides a flexible mechanism to describe, in natural language, the desired output using the data of the analytics engine. A single “prompt-based report” could produce many different reports, replacing all existing reports and providing an infinite number of possible outputs. With detailed prompting, it is possible to request specific columns, filtering, ordering or limiting. This approach facilitates including and utilizing additional datasets added to the data store in the future.

However, with the stochastic nature of LLMs, there is no absolute guarantee that a specific prompt will give the user a predictable output, no matter how precise the prompting is. Because these prompts are open, it is possible to request data that would overwhelm the system and cause a “Denial of Service” type result. This prompt mechanism might also open the door to “SQL injection,” where a maliciously crafted prompt could request to change or delete data in the data store.

To mitigate these issues the client could use a mechanism to validate that the output includes the right columns. This could be limited to an internal API used by first-party developers. The approach could also add specific code to limit the resources that a single request can use. The approach could add specific code to make sure the results only query the data to avoid SQL injection, i.e., no requests to delete or alter data can be submitted via this mechanism.

In production environments, the system could have a specific list of allowed semantic patterns for a user description of the query to be generated. This is to avoid a malicious or damaging description from being processed. More specifically, the API handler may require the user description to match one of a number of approved semantic patterns in order to protect the database of the analytics engine. If a natural language description provided by the user fails to match an approved pattern, the request may not be implemented to protect the system. The user may be prompted to attempt a revised description that might match an approved pattern. A limit may be placed on the attempts the user is allowed to input without matching an approved pattern.

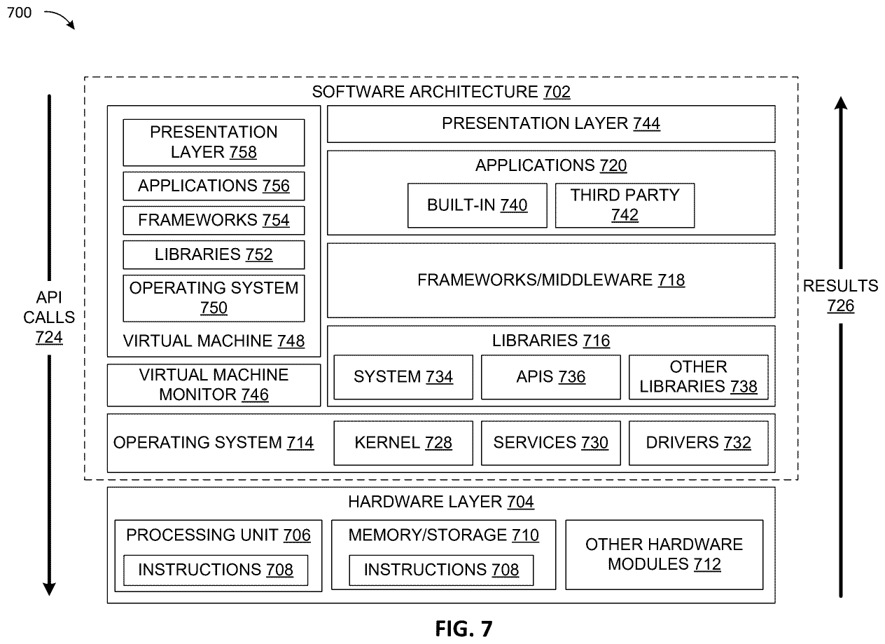

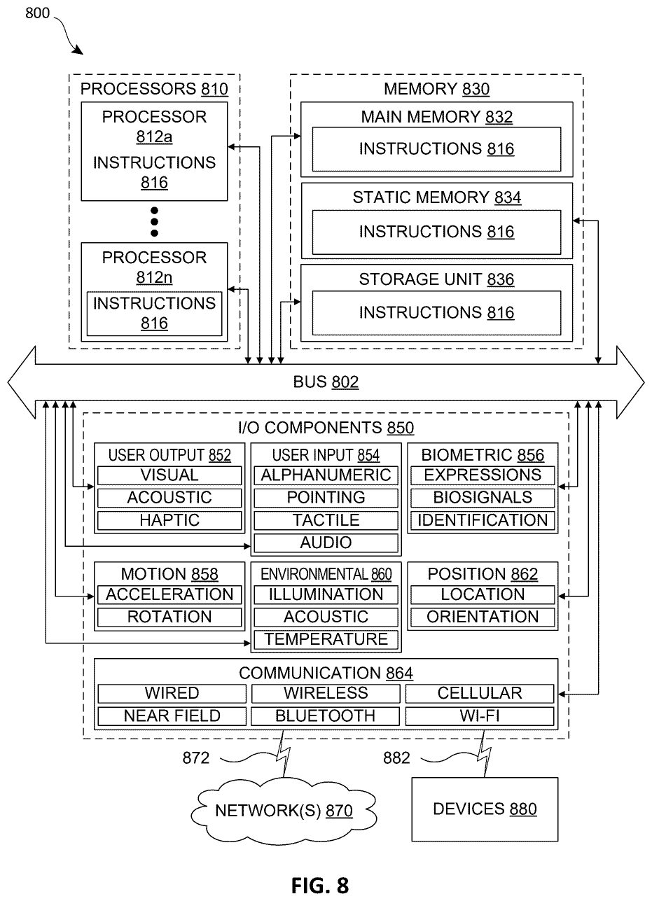

FIG. 7 is a block diagram 700 illustrating an example software architecture 702, various portions of which may be used in conjunction with various hardware architectures herein described, which may implement any of the above-described features. FIG. 7 is a non-limiting example of a software architecture, and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 706 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 750, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed.

As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 864, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-6) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the foregoing detailed description, numerous specific details were set forth by way of examples in order to provide a thorough understanding of the relevant teachings. It will be apparent to persons of ordinary skill, upon reading the description, that various aspects can be practiced without such details. In other instances, well known methods, procedures, components, and/or circuitry have been described at a relatively high-level, without detail, in order to avoid unnecessarily obscuring aspects of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory in communication with the processor, the memory comprising executable instructions that, when executed by the processor alone or in combination with other processors, cause the data processing system to implement an Application Programming Interface (API) handler for an analytics engine, the API handler to perform functions of:
receiving user input including a natural language description that defines data a user wants from the analytics engine;
generating a submission for a generative artificial intelligence (GenAI) based on the user input, the submission including the natural language description, schema of datasets stored in a database of the analytics engine, and an instruction to produce a query for the database;
submitting the generated submission to the GenAI and receiving a corresponding query from the GenAI;
submitting the query from the GenAI to the database of the analytics engine to generate a result set specific to the natural language description of the user input; and
outputting, via an API, the result set.

2. The data processing system of claim 1, wherein the GenAI comprises a Large Language Model (LLM).

3. The data processing system of claim 2, wherein the LLM is a generally-trained LLM.

4. The data processing system of claim 1, wherein the GenAI is a Generative Pre-Trained Transformer (GPT).

5. The data processing system of claim 1, the API handler further performing requiring the description to match one of a number of approved semantic patterns to protect the database of the analytics engine.

6. The data processing system of claim 1, wherein the API returns the result set in an API response to an application from which the user input was received.

7. The data processing system of claim 1, wherein the schema of the datasets is stored in a grounding database accessible to a prompt generator of the API handler.

8. The data processing system of claim 1, wherein the database of the analytics engine is a Structure Query Language (SQL) database and the prompt instructs the GenAI to generate an SQL query for the database of the analytics engine.

9. A data processing system comprising:
an Application Programming Interface (API) to receive user input including a natural language description defining data a user wants from an analytics engine;
a prompt generator and grounding database, the prompt generator to generate a submission comprising grounding data from the grounding database, the grounding data including schema of a database of the analytics engine, the submission further comprising the user input and a prompt to produce a query for the database of the analytics engine; and
an Application Programming Interface (API) handler to input the generated submission to a Generative Artificial Intelligence (GenAI) and receive a corresponding query from the GenAI, the API handler further to submit the query to the database of the analytics engine and receive a result set specific to the user input, the API handler further to return the result set in an API response.

10. The data processing system of claim 9, wherein the GenAI comprises a Large Language Model (LLM).

11. The data processing system of claim 10, wherein the LLM is a generally-trained LLM.

12. The data processing system of claim 9, wherein the GenAI is a Generative Pre-Trained Transformer (GPT).

13. The data processing system of claim 9, the API handler further requiring the description to match one of a number of approved semantic patterns to protect the database of the analytics engine.

14. The data processing system of claim 13, the API handler to discard a description not matching any of the approved patterns.

15. The data processing system of claim 13, the API handler to advise the user to input a new description in response to a current description not matching any of the approved patterns.

16. The data processing system of claim 9, wherein the API returns the result set in the API response to an application from which the user input was received.

17. The data processing system of claim 9, wherein the database of the analytics engine is a Structure Query Language (SQL) database and the prompt instructs the GenAI to generate an SQL query for the database of the analytics engine.

18. A method of operating an analytics engine to obtain a specific data output specified by user input, the method comprising:
receiving the user input including a natural language description that defines data a user wants from the analytics engine;
generating a submission for a generative artificial intelligence (GenAI) based on the user input, the submission including the natural language description, schema of datasets stored in a database of the analytics engine, and an instruction to produce a query for the database in a format compatible with the database of the analytics engine;
submitting the generated submission to the GenAI and receiving a corresponding query from the GenAI;
submitting the query from the GenAI to the database of the analytics engine to generate a result set specific to the natural language description of the user input; and
outputting the result set via an Application Programming Interface (API) to a system from which the user input was received.

19. The method of claim 18, wherein the GenAI comprises a Large Language Model (LLM).

20. The method of claim 18, further comprising, prior to submission to the GenAI, requiring the description to match one of a number of approved semantic patterns to protect the database of the analytics engine.
